(19) United States
(12) Patent Application Publication
(10) Pub. No.: US 2023/0311856 A1
(43) Pub. Date: Oct. 5, 2023

(54) METHOD FOR PERFORMING AN AVP OPERATION OF A MOTOR VEHICLE

(71) Applicant: Robert Bosch GmbH, Stuttgart (DE)

(72) Inventor: Stefan Nordbruch, Leonberg (DE)

(21) Appl. No.: 18/179,541

(22) Filed: Mar. 7, 2023

(30) Foreign Application Priority Data
Apr. 1, 2022 (DE) 10 2022 203 269.1

(51) Int. Cl. B60W 30/06; B60W 60/00; H04W 4/44

(52) U.S. Cl. CPC B60W 30/06; B60W 60/001; H04W 4/44; B60W 2556/45; B60W 2552/00

(57) ABSTRACT

A method for performing an AVP operation of a motor vehicle within a parking lot. During a performance of the AVP operation based on one AVP type selected from the following group of AVP types: AVP type 1, AVP type 2 and AVP type 3, wherein AVP type 1 is a vehicle-centered AVP operation, wherein AVP type 2 is an infrastructure-centered AVP operation, and wherein AVP type 3 is a shared vehicle-infrastructure AVP operation, a test is carried out as to whether at least one predetermined switching condition is fulfilled for a planned switch of the performance of the AVP operation from the one AVP type to another AVP type. Depending on the test, the planned switch is released in order to continue the AVP operation.

### CROSS REFERENCE

The present application claims the benefit under 35 U.S.C. § 119 of German Patent Application No. DE 10 2022 203 269.1 filed on Apr. 1, 2022, which is expressly incorporated herein by reference in its entirety.

### FIELD

The present invention relates to a method for performing an AVP operation of a motor vehicle within a parking lot, to a device, a computer program and a machine-readable storage medium.

### BACKGROUND INFORMATION

German Patent Application No. DE 10 2012 222 562 A1 describes a system for managed parking areas for transferring a vehicle from a start position to a target position.

### SUMMARY

An object underlying the present invention is to provide a concept for the efficient performance of an AVP operation of a motor vehicle within a parking lot.

This object may be achieved by features of the present invention. Advantageous embodiments of the present invention are disclosed herein.

According to a first aspect of the present invention, a method for performing an AVP operation of a motor vehicle within a parking lot is provided. According to an example embodiment of the present invention, during a performance of the AVP operation based on one AVP type selected from the following group of AVP types: AVP type 1, AVP type 2 and AVP type 3, wherein AVP type 1 is a vehicle-centered AVP operation, wherein AVP type 2 is an infrastructure-centered AVP operation, and wherein AVP type 3 is a shared vehicle-infrastructure AVP operation, a test is carried out as to whether at least one predetermined switching condition is fulfilled for a planned switch of the performance of the AVP operation from the one AVP type to another AVP type, wherein, depending on the test, the planned switch is released in order to continue the AVP operation.

According to a second aspect of the present invention, a device is provided, which is configured to carry out all steps of the method according to the first aspect of the present invention.

According to a third aspect of the present invention, a computer program is provided, which comprises instructions that, when the computer program is executed by a computer, for example by the device according to the second aspect of the present invention, cause said computer to carry out a method according to the first aspect of the present invention.

According to a fourth aspect of the present invention, a machine-readable storage medium is provided, on which the computer program according to the third aspect of the present invention is stored.

The present invention is based on and includes the knowledge that the above object can be achieved by testing, prior to a planned switch of the performance based on the one AVP type to the other AVP type, whether one or more switching conditions are fulfilled. Only if the one or more switching conditions are fulfilled will the planned switch be released. Otherwise, for example, the release is denied. For example, in such a case, it is specified that the motor vehicle is to be transferred into a safe state, for example, to be stopped.

Thus, a concept for efficiently performing an AVP operation of a motor vehicle within a parking lot is provided.

The abbreviation “AVP” stands for “Automated Valet Parking” and can be translated into German as “automatischer Parkservice.” An AVP operation comprises, for example, at least highly automated guidance of the motor vehicle from a drop-off position to a parking position and, for example, at least highly automated guidance of the motor vehicle from a parking position to a pick-up position. At the drop-off position, a driver of the motor vehicle drops the motor vehicle off for an AVP operation. At a pick-up position, the motor vehicle is picked up after the AVP operation has ended.

A motor vehicle within the meaning of the description can thus also be referred to as an AVP motor vehicle insofar as it is configured, for example, to perform an AVP operation.

For example, it is provided that the AVP operation comprises an AVP operation according to AVP type 1, 2, and/or 3, wherein AVP type 1 is a vehicle-centered AVP operation, wherein AVP type 2 is an infrastructure-centered AVP operation, and wherein AVP type 3 is a shared vehicle-infrastructure AVP operation.

This, for example, brings about the technical advantage that the AVP operation can be performed efficiently.

AVP type 1 denotes a vehicle-centered AVP operation. The primary responsibility for the AVP operation rests with the motor vehicle.

AVP type 2 denotes an infrastructure-centered AVP operation. The primary responsibility for the AVP operation rests with the infrastructure, i.e., with the AVP system.

AVP type 3 denotes a shared vehicle-infrastructure AVP operation. Here, a primary responsibility for the AVP operation is shared between the motor vehicle and the AVP system.

An AVP operation comprises the following operations or functions:
1. Determining a target position, located within the parking lot, for the motor vehicle.
2. Planning a route from a start position, comprised by the parking lot, to the target position.
3. Detecting an object and/or an event and responding accordingly to a detected object and/or a detected event.
4. Locating the motor vehicle within the parking lot.
5. Calculating a desired trajectory for the motor vehicle based on the planned route.
6. Controlling a lateral and longitudinal guidance of the motor vehicle based on the calculated desired trajectory.

An assignment as to which of these operations or functions are performed, depending on the AVP type, by the motor vehicle or by an infrastructure AVP system, which may comprise, for example, the system according to the second aspect, is indicated by the following table, wherein “I” stands for “infrastructure,” i.e., for the AVP system, and “K” stands for “motor vehicle” so that “I” indicates that the operation is performed by the AVP system, and “K” indicates that the operation is performed by the motor vehicle:

| Functions | AVP type 1 | AVP type 2 | AVP type 3 |
|---|---|---|---|
| Determining a | I & K | I | I |
| target position, | | | |
| located within the | | | |
| parking lot, for | | | |
| the motor vehicle. | | | |
| Planning a route | K | I | I |
| from a start | | | |
| position, | | | |
| comprised by the | | | |
| parking lot, to | | | |
| the target | | | |
| position. | | | |
| Detecting an | K ( & | I | I & K |
| object and/or an | optionally | | |
| event and | I) | | |
| responding | | | |
| accordingly to a | | | |
| detected object | | | |
| and/or a detected | | | |
| event. | | | |
| Locating the motor | K | I | K |
| vehicle within the | | | |
| parking lot. | | | |
| Calculating a | K | I | K |
| desired trajectory | | | |
| for the motor | | | |
| vehicle based on | | | |
| the planned route. | | | |
| Controlling a | K | K | K |
| lateral and | | | |
| longitudinal | | | |
| guidance of the | | | |
| motor vehicle | | | |
| based on the | | | |
| calculated desired | | | |
| trajectory. | | | |

The table above thus indicates specifically for each AVP type for each function whether the function is performed by the infrastructure, i.e., by an infrastructure AVP system, or by the motor vehicle, i.e., for example, by an on-board AVP system. In some cases, it may be provided that the function is carried out by both the infrastructure AVP system and the motor vehicle, i.e., the on-board AVP system.

With regard to object detection and event detection for AVP type 1, it may optionally be provided that in addition to the motor vehicle, the AVP system of the infrastructure also carries out this function.

The AVP types 1, 2, and 3 described herein are also described in detail in ISO 23374.

The phrase “at least partly automated guidance” includes one or more of the following cases: assisted guidance, partly automated guidance, highly automated guidance, fully automated guidance. The phrase “at least partly automated” thus includes one or more of the following phrases: assisted, partly automated, highly automated, fully automated.

Assisted guidance means that a driver of the motor vehicle permanently carries out either the lateral or the longitudinal guidance of the motor vehicle. The respectively other driving task (i.e., controlling the longitudinal or lateral guidance of the motor vehicle) is carried out automatically. That is to say, in an assisted guidance of the motor vehicle, either the lateral guidance or the longitudinal guidance is controlled automatically.

Partly automated guidance means that in a specific situation (for example: driving on a highway, driving within a parking lot, overtaking an object, driving within a lane defined by lane markings) and/or for a certain period of time, longitudinal and lateral guidance of the motor vehicle is automatically controlled. A driver of the motor vehicle does not have to manually control the longitudinal and lateral guidance of the motor vehicle. However, the driver have to continually monitor the automatic control of the longitudinal and lateral guidance in order to be able to manually intervene if necessary. The driver must be ready at all times to fully take over motor vehicle guidance.

Highly automated guidance means that for a certain period of time, in a specific situation (for example: driving on a highway, driving within a parking lot, overtaking an object, driving within a lane defined by lane markings), longitudinal guidance and lateral guidance of the motor vehicle are controlled automatically. A driver of the motor vehicle does not have to manually control the longitudinal and lateral guidance of the motor vehicle. The driver does not have to continually monitor the automatic control of the longitudinal and lateral guidance in order to be able to intervene manually if necessary. If necessary, a take-over request is automatically issued to the driver to take over control of the longitudinal and lateral guidance, in particular issued with sufficient time to spare. The driver thus must potentially be able to take control of the longitudinal and lateral guidance. Limits of automatically controlling the lateral and longitudinal guidance are recognized automatically. In the case of highly automated guidance, it is not possible to automatically bring about a minimum-risk condition in every initial situation.

Fully automated guidance means that in a specific situation (for example: driving on a highway, driving within a parking lot, overtaking an object, driving within a lane defined by lane markings), longitudinal guidance and lateral guidance of the motor vehicle are controlled automatically. A driver of the motor vehicle does not have to manually control the longitudinal and lateral guidance of the motor vehicle. The driver does not have to monitor the automatic control of the longitudinal and lateral guidance in order to be able to manually intervene if necessary. Before ending the automatic control of the lateral and longitudinal guidance, the driver is automatically asked to take over the driving task (controlling the lateral and longitudinal guidance of the motor vehicle), in particular with sufficient time to spare. If the driver does not take over the driving task, it is automatically returned to a minimum-risk condition. Limits of automatically controlling the lateral and longitudinal guidance are recognized automatically. In all situations, it is possible to automatically return to a minimum-risk system condition.

In one embodiment of the method of the present invention, it is provided that upon release and after a corresponding, planned switch, during the continuation of the AVP operation based on the other AVP type, at least one function of the one AVP type is to be used as the fallback level and/or as the review level for performing the AVP operation based on the other AVP type.

This, for example, brings about the technical advantage that the AVP operation can continue efficiently.

For example, according to an example embodiment of the present invention, it is provided that during the continuation of the AVP operation based on the other AVP type, a background AVP operation based on the one AVP type is performed in parallel in the background in addition to the continued AVP operation, wherein the background AVP operation only runs virtually but is not actually implemented by the motor vehicle. The background AVP operation may, for example, be used as the fallback level and/or, for example, as the review level. As the fallback level, for example, if there is an error in the continued AVP operation and/or if there is an error during the switch. In this case, for example, a switch back to the one AVP type is carried out. As the review level, for example, in order to check the continued AVP operation for accuracy and/or plausibility, for example. If an error occurs, it may, for example, be provided to transfer the motor vehicle into a safe state, for example, to stop it.

In one example embodiment of the method of the present invention, it is provided that the at least one switching condition is in each case an element selected from the following group of switching conditions: AVP system of the motor vehicle and/or AVP system of the infrastructure are each ready to perform at least one function of the other AVP type, which the motor vehicle and/or the infrastructure are to perform according to the other AVP type; a localization of the motor vehicle according to the one AVP type matches a localization of the motor vehicle according to the other AVP type, in particular within a predetermined tolerance range; the motor vehicle was identified, in particular re-identified, by the infrastructure; data for continuing the AVP operation based on the other AVP type are available; reception of a heartbeat message transmitted by the infrastructure; reception of a heartbeat message transmitted by the motor vehicle; the motor vehicle was correctly identified by the infrastructure.

This, for example, brings about the technical advantage that particularly suitable switching conditions can be selected.

According to an example embodiment of the present invention heartbeat messages are expected by a receiver at predefined intervals. If a correspondingly expected heartbeat message is not received, the receiver assumes that an error has occurred, for example an error in a communication link between the infrastructure and the motor vehicle. A heartbeat message may, for example, not be received if an error has occurred in the infrastructure or in the motor vehicle. An error may have occurred in an AVP system, for example. Since heartbeat messages can no longer be transmitted in such a case, the receiver of the heartbeat message thus knows that the motor vehicle and/or the infrastructure are not ready to continue the AVP operation based on the other AVP type.

An AVP system within the meaning of the description is configured to perform an AVP operation for a motor vehicle within the parking lot.

An AVP system is, for example, an infrastructure AVP system, i.e., an AVP system of the motor vehicle.

An AVP system is, for example, an on-board AVP system, i.e., an AVP system comprised by the motor vehicle.

For example, both an AVP system of the infrastructure, i.e., of the parking lot, and an AVP system of the motor vehicle are provided.

Explanations made in connection with an on-board AVP system apply analogously to an infrastructure AVP system, i.e., to a parking-lot AVP system, and vice versa.

If the AVP system is further defined in the description without further specification regarding the motor vehicle or the infrastructure, “on-board” and “infrastructure,” i.e., “parking-lot,” should always be inferred.

According to one embodiment of the method of the present invention, it is provided that the AVP system comprises at least one environmental sensor configured to detect an environment of the motor vehicle.

Readiness of the AVP system comprises, for example, readiness of the at least one environmental sensor to detect the environment of the motor vehicle.

In one embodiment of the method of the present invention, it is provided that the AVP system comprises at least one computer configured to evaluate environmental data based on the detected environment in order to perform the AVP operation based on the evaluation. For example, the readiness of the AVP system comprises a readiness of the computer.

In one embodiment of the method of the present invention, it is provided that the at least one function is in each case an element selected from the following group of functions: determining a target position, located within the parking lot, for the motor vehicle; planning a route from a start position, comprised by the parking lot, to the target position; detecting an object and/or an event and responding accordingly to a detected object and/or a detected event; locating the motor vehicle within the parking lot; calculating a desired trajectory and/or a driving tube and/or a safety area, which must be free of collision objects, for the motor vehicle based on the planned route; controlling a lateral and longitudinal guidance of the motor vehicle based on the calculated desired trajectory and/or the calculated driving tube and/or the calculated safety area; specifying at least one traversing condition, in particular speed and/or acceleration, when the motor vehicle drives away from a start position of the parking lot; determining at least one item of context information, in particular traffic rule(s), accident black spot(s), of the route and/or of the target position, wherein the context information is determined in particular using a digital map of the parking lot; determining a switching position of the parking lot where the switch is to be performed; determining a switching area of the parking lot within which the switch is to be performed; monitoring of the motor vehicle by the infrastructure as it drives within the parking lot.

This, for example, brings about the technical advantage that particularly suitable functions can be provided.

In one embodiment of the method of the present invention, it is provided that one or more or all of the method steps are performed by the infrastructure, in particular in a cloud infrastructure, and/or by the motor vehicle.

This, for example, may bring about the technical advantage that the individual method steps can be performed efficiently.

An environmental sensor within the meaning of the description is, for example, one of the following environmental sensors: radar sensor, image sensor, in particular image sensor of a video camera, ultrasonic sensor, LiDAR sensor, magnetic field sensor and infrared sensor.

An environmental sensor within the meaning of the description is, for example, configured to detect an environment of the motor vehicle and to output environmental data based on the detection.

For example, one or more environmental sensors are arranged spatially distributed within the parking lot.

For example, the motor vehicle comprises one or more environmental sensors.

In one embodiment of the method of the present invention, it is provided that the method is a computer-implemented method.

Technical functionalities of the device result directly from corresponding technical functionalities of the method, and vice versa.

In one embodiment of the method of the present invention, it is provided that the method is performed by the device.

The phrase “at least one” means “one or more.”

The present invention is explained in more detail below using preferred exemplary embodiments.

### BRIEF DESCRIPTION OF THE DRAWINGS

FIG. 1 shows a flow chart of an example method according to the first aspect of the present invention.

FIG. 2 shows an example device according to the second aspect of the present invention.

FIG. 3 shows an example machine-readable storage medium according to the fourth aspect of the present invention.

FIG. 4 shows a parking lot.

### DETAILED DESCRIPTION OF EXAMPLE EMBODIMENTS

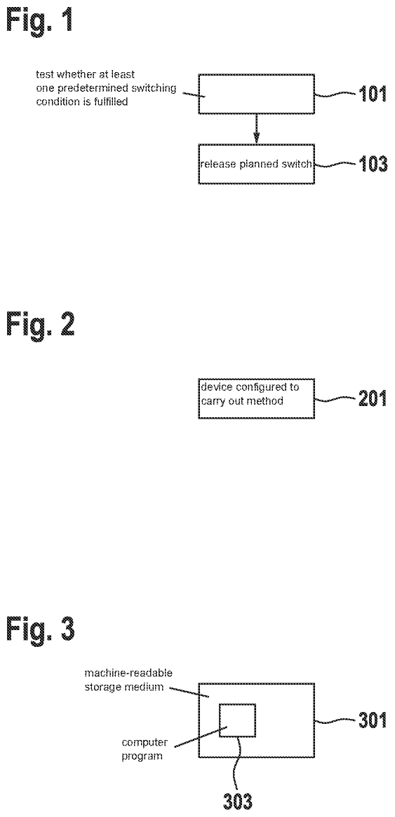

FIG. 1 shows a flow chart of a method for performing an AVP operation of a motor vehicle within a parking lot, wherein during a performance of the AVP operation based on one AVP type selected from the following group of AVP types: AVP type 1, AVP type 2 and AVP type 3, wherein AVP type 1 is a vehicle-centered AVP operation, wherein AVP type 2 is an infrastructure-centered AVP operation, and wherein AVP type 3 is a shared vehicle-infrastructure AVP operation, a test 101 is carried out as to whether at least one predetermined switching condition is fulfilled for a planned switch of the performance of the AVP operation from the one AVP type to another AVP type, wherein, depending on the test 101, the planned switch is released 103 in order to continue the AVP operation.

In one embodiment of the method, the release comprises transmitting a release command to the motor vehicle and/or to the infrastructure via a communication network, for example a WLAN network and/or a cellular network.

For example, the motor vehicle transmits the release command to the infrastructure. For example, the infrastructure transmits a release command to the motor vehicle.

In one embodiment of the method, the method comprises the step of continuing the AVP operation based on the other AVP type.

In one embodiment of the method, it is provided that at least one function of the one AVP type is used as the fallback level and/or as the review level for performing the AVP operation based on the other AVP type.

In one embodiment of the method, this comprises switching the performance of the AVP operation from one AVP type to the other AVP type after release of the planned switch.

FIG. 2 shows a device 201, which is configured to carry out all steps of the method according to the first aspect.

FIG. 3 shows a machine-readable storage medium 301, in which a computer program 303 is stored. The computer program 303 comprises instructions that, when the computer program 303 is executed by a computer, cause the latter to carry out a method according to the first aspect.

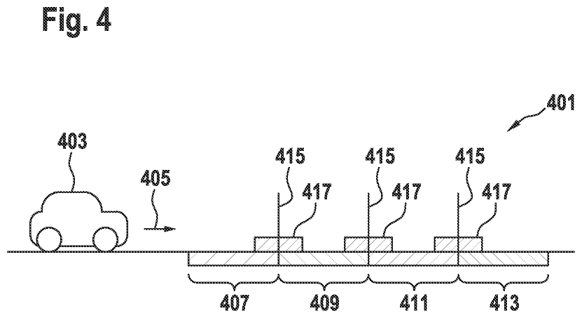

FIG. 4 shows a parking lot 401 within which a motor vehicle 403 drives in an at least partially automated manner in the driving direction 405. The driving direction 405 is from left to right in relation to the paper plane.

The motor vehicle 403 performs an AVP operation. Within the parking lot 401, several areas are defined within which the AVP operation is performed based on a particular AVP type.

A first area 407 and a second area 409 and a third area 411 and a fourth area 413 are provided. The second area 409 directly adjoins the first area 407. The third area 411 directly adjoins the second area 409. The fourth area 413 directly adjoins the third area 411. Within these four areas 407, 409, 411, 413, the AVP operation is performed based on one AVP type. For example, in the first area 407, the AVP operation is performed based on AVP type 2. For example, in the second area 409, the AVP operation is performed based on AVP type 1. For example, in the third area 411, the AVP operation is performed based on AVP type 2. For example, in the fourth area 413, the AVP operation is performed based on AVP type 3.

For example, it is planned to perform the switch of the performance of the AVP operation from one AVP type to another AVP type exactly at a boundary between two areas. These boundaries are symbolically denoted by vertical dashes with reference sign 415.

For example, it is provided that a corresponding switch is performed within switching areas 417 which are symbolically represented by quadrilaterals and which each partially overlap two directly adjacent areas.

Before such a planned switch is performed, it is provided according to the concept described herein that a test is carried out as to whether one or more predetermined switching conditions are fulfilled for such a planned switch. If this is the case, the switch is released. That is to say, the switch is carried out. If this is not the case, the switch is not released, i.e., the switch is not carried out.

The switch can, for example, be performed during a standstill of the motor vehicle or while driving the motor vehicle, i.e., during a performance of the AVP operation.

If, for example, while driving the motor vehicle, a switch is carried out, it is provided according to one embodiment of the method that, during the continuation of the AVP operation based on the other AVP type, at least one function of the one AVP type is used as the fallback level and/or as the review level for performing the AVP operation based on the other AVP type.

Before starting a performance of the AVP operation, it is, for example, provided that a determination is carried out as to which AVP types are supported by the motor vehicle and/or the infrastructure, i.e., the parking lot.

For example, it is provided that the test comprises testing whether an on-board and/or infrastructure AVP system is ready for a switch, i.e., is in particular alive. This means that a test is carried out as to whether the systems necessary for performing the AVP operation are functioning properly. This may be performed using heartbeat messages. The test whether the systems in a motor vehicle and/or infrastructure are functional can, for example, be performed once or can, for example, be performed several times, in particular periodically.

A heartbeat message comprises, for example, a specific datum and/or a datum necessary for the at least one function, which datum can, for example, indicate that a particular area is free or occupied.

For example, it is provided that the motor vehicle is clearly identified, in particular re-identified. This is in particular provided if the motor vehicle, for example, comes from an area within which the AVP operation is performed based on AVP type 1, wherein within the subsequent area, the AVP operation is performed based on AVP type 2, since the infrastructure must in this case identify, in particular re-identify, the motor vehicle.

For example, it is provided that the motor vehicle is located, in particular re-located. This is in particular provided if the motor vehicle comes from an area within which the AVP operation is performed based on AVP type 1, wherein within the subsequent area, the AVP operation is performed based on AVP type 2, so that the infrastructure needs to locate, in particular re-locate, the motor vehicle.

For example, it is provided that a test is carried out as to whether the data necessary for performing the AVP operation based on the other AVP type are available and provided. If, for example, the other AVP type is AVP type 3, the motor vehicle requires, for example, a route and a target position from the infrastructure for the performance of the AVP operation. If, for example, the other AVP type is AVP type 2, the motor vehicle requires, for example, a desired trajectory to be traversed, from the infrastructure.

For example, it is provided that a test is carried out as to whether the data match. For example, it is provided that a test is carried out as to whether the current localization, i.e., the localization of the motor vehicle according to the one AVP type, matches the new localization, i.e., the localization of the motor vehicle according to the other AVP type. For example, the one AVP type is AVP type 1 so that the motor vehicle locates itself. After the planned switch, the other AVP type is, for example, AVP type 2 so that the infrastructure locates the motor vehicle. However, prior to the switch, the infrastructure already locates the motor vehicle. For example, a switching condition specifies that both localizations, i.e., the localization by the motor vehicle and the localization already performed by the infrastructure prior to the switch, must match, in particular within a predetermined tolerance range, for the switch to be carried out.

If the one or more switching conditions are fulfilled, it is, for example, provided that a switch is carried out.

One or more or all of the method steps may be performed, for example, by the infrastructure and/or by the motor vehicle. The infrastructure performing a method step comprises, for example, performing the corresponding method step in a cloud infrastructure.

What is claimed is:

1. A method for performing an AVP operation of a motor vehicle within a parking lot, the method comprising the following steps:
during a performance of the AVP operation based on one AVP type selected from the following group of AVP types: AVP type 1, AVP type 2 and AVP type 3, wherein AVP type 1 is a vehicle-centered AVP operation, wherein AVP type 2 is an infrastructure-centered AVP operation, and wherein AVP type 3 is a shared vehicle-infrastructure AVP operation, carrying out a test as to whether at least one predetermined switching condition is fulfilled for a planned switch of the performance of the AVP operation from the one AVP type to another AVP type; and
releasing, depending on a result of the test, the planned switch to continue the AVP operation.

2. The method according to claim 1, further comprising:
upon release and after the planned switch, during the continuation of the AVP operation based on the other AVP type, using at least one function of the one AVP type as a fallback level and/or as a review level for performing the AVP operation based on the other AVP type.

3. The method according to claim 1, wherein each of the at least one predetermined switching condition is an element selected from the following group of switching conditions: (i) an AVP system of the motor vehicle and/or an AVP system of an infrastructure is ready to perform at least one function of the other AVP type, which the motor vehicle and/or the infrastructure are to perform according to the other AVP type; (ii) a localization of the motor vehicle according to the one AVP type matches a localization of the motor vehicle according to the other AVP type within a predetermined tolerance range; (iii) the motor vehicle was re-identified by the infrastructure; (iv) data for continuing the AVP operation based on the other AVP type are available; (iv) reception of a heartbeat message transmitted by the infrastructure; (v) reception of a heartbeat message transmitted by the motor vehicle; (vi) the motor vehicle was correctly identified by the infrastructure.

4. The method according to claim 2, wherein each of the at least one function is an element selected from the following group of functions: (i) determining a target position, located within the parking lot, for the motor vehicle; (ii) planning a route from a start position, included in the parking lot, to the target position; (iii) detecting an object and/or an event and responding accordingly to a detected object and/or a detected event; (iv) locating the motor vehicle within the parking lot; (v) calculating a desired trajectory and/or a driving tube and/or a safety area, which must be free of collision objects, for the motor vehicle based on the planned route; (vi) controlling a lateral and longitudinal guidance of the motor vehicle based on the calculated desired trajectory and/or the calculated driving tube and/or the calculated safety area; (vii) specifying at least one traversing condition including speed and/or acceleration when the motor vehicle drives away from a start position of the parking lot; (viii) determining at least one item of context information including traffic rule(s) of the route, and/or accident black spot(s) of the route and/or traffic rule(s) of the target position, and/or accident black spot(s) of the target position, wherein the context information is determined in using a digital map of the parking lot; (ix) determining a switching position of the parking lot where the planned switch is to be performed; (x) determining a switching area of the parking lot within which the planned switch is to be performed; (xi) monitoring of the motor vehicle by the infrastructure as the motor vehicle drives within the parking lot.

5. The method according to claim 1, wherein one or more or all of the method steps are performed by an infrastructure and/or by the motor vehicle.

6. A device configured to perform an AVP operation of a motor vehicle within a parking lot, the device configured to:
during a performance of the AVP operation based on one AVP type selected from the following group of AVP types: AVP type 1, AVP type 2 and AVP type 3, wherein AVP type 1 is a vehicle-centered AVP operation, wherein AVP type 2 is an infrastructure-centered AVP operation, and wherein AVP type 3 is a shared vehicle-infrastructure AVP operation, carry out a test as to whether at least one predetermined switching condition is fulfilled for a planned switch of the performance of the AVP operation from the one AVP type to another AVP type; and
release, depending on a result of the test, the planned switch to continue the AVP operation.

7. A non-transitory machine-readable storage medium on which is stored a computer program for performing an AVP operation of a motor vehicle within a parking lot, the computer program, when executed by a computer, causing the computer to perform the following steps:
during a performance of the AVP operation based on one AVP type selected from the following group of AVP types: AVP type 1, AVP type 2 and AVP type 3, wherein AVP type 1 is a vehicle-centered AVP operation, wherein AVP type 2 is an infrastructure-centered AVP operation, and wherein AVP type 3 is a shared vehicle-infrastructure AVP operation, carrying out a test as to whether at least one predetermined switching condition is fulfilled for a planned switch of the performance of the AVP operation from the one AVP type to another AVP type; and
releasing, depending on a result of the test, the planned switch to continue the AVP operation.
